(19) United States
(12) Patent Application Publication
(10) Pub. No.: US 2026/0170340 A1
(43) Pub. Date: Jun. 18, 2026

(54) UNIFIED METHOD, MEDIUM AND PRODUCT FOR TRAINING NEURAL OPERATORS AND SOLVING PARTIAL DIFFERENTIAL EQUATIONS (PDES) BASED ON VARIATIONAL PRINCIPLES

(71) Applicant: DALIAN UNIVERSITY OF TECHNOLOGY, Dalian, Liaoning (CN)

(72) Inventors: Tengfei XU, Dalian, Liaoning (CN); Peng HAO, Dalian, Liaoning (CN); Dachuan LIU, Dalian, Liaoning (CN)

(21) Appl. No.: 18/710,462

(22) PCT Filed: Jan. 3, 2024
(86) PCT No.: PCT/CN2024/070340

§ 371 Date: May 15, 2024

(30) Foreign Application Priority Data
Mar. 30, 2023 (CN) 202310326728.2

(51) Int. Cl. G06N 3/084

(52) U.S. Cl. CPC G06N 3/084

(57) ABSTRACT

The present invention proposes a unified method, medium and product for training neural operators and solving partial differential equations (PDEs) based on variational principles, comprising: sampling the parameter space of PDEs to form a dataset containing only discrete parameter fields, dividing the dataset into a shift set, a test set and a label-free set, dividing the label-free set into multiple batches, and forming a mask tensor of the boundary conditions; using a neural operator module to predict node solutions of the discrete parameter field samples in the label-free set to obtain a discretized functional as a system functional estimate; and calculating the gradient R of the functional estimate with respect to the node solutions, taking the norm thereof as a minimized objective, acquiring an update stride of the current node solution, and updating the weight of the module.

### TECHNICAL FIELD

The present invention belongs to the crossing field of physical simulation and machine learning, and particularly relates to a unified method, medium and product for training neural operators and solving partial differential equations (PDEs) based on variational principles.

### BACKGROUND

Compared with traditional surrogate models such as a Gaussian process model and a radial basis function model, a neural operator, as a deep neural network that can effectively learn mapping operators between the parameter space and the solution space of PDEs, can conduct high-accuracy immediate inference for the whole solution domain of PDEs, and has attracted wide attention in many physical simulation fields such as fluid, solid, electromagnetism and heat transfer. The neural operator has many advantages of potential super-resolution, high flexibility and excellent generalization performance, has a huge floor space in industries such as digital twin of industrial equipment, real-time and large-scale simulation solution, animation game modeling and rendering, and metaverse, and is very likely to become the core technology of the next generation of physical simulation solvers.

However, the existing data-driven training methods for neural operators require massive label data from traditional solvers, which leads to the heavy use of traditional solvers and thus brings a huge computational burden. In addition, the training process also incurs a certain calculation cost.

### SUMMARY

In view of the defects in existing data-driven neural operator training methods, the present invention proposes a unified method, medium and product for training neural operators and solving PDEs based on variational principles, which estimate a discrete functional through predicted node solutions of neural operators, use iterative methods for systems of equations to minimize the gradient norm of the discrete functional obtained by automatic differentiation with respect to the node solutions, and construct label-free optimization objectives to train the neural operators, so as to avoid the heavy use of traditional solvers to obtain labels, thus saving the calculation cost. Meanwhile, the method uses the generalization ability of neural operators to provide good initial solutions for each iteration, essentially integrating training and solving into a unified framework.

To achieve the above purpose, the present invention adopts the following technical solution:

In a first aspect, a unified method for training neural operators and solving PDEs based on variational principles, comprising the following steps:

Step 100: sampling the parameter space of PDEs to form a label-free dataset D containing only discrete parameter fields, dividing the dataset D into a shift set L, a test set T and a label-free set U, dividing the label-free set U into multiple batches, and encoding boundary conditions to form a mask tensor of the boundary conditions, comprising the following substeps:

Step 101: selecting a form and a sampling strategy of the parameter space of PDEs;

Step 102: meshing the solution domain of PDEs, sampling the parameter space of PDEs according to the sampling strategy selected in step 101, and discretizing sampled parameter fields at a Gauss point of the mesh to form a label-free discrete parameter field dataset D containing only discrete parameter fields, specifically: determining the number of the sampled discrete parameter fields and the shape of the discrete parameter fields;

Step 103: randomly sampling (N₁+N₂) discrete parameter fields from the discrete parameter field dataset D, obtaining node solutions of PDEs corresponding to the (N₁+N₂) discrete parameter fields, and taking the first N₁ discrete parameter fields and the corresponding node solutions (labels) as the shift set L and the remaining N₂ discrete parameter fields and the corresponding node solutions as the test set T, wherein the shift set L is used for shifting the output range, with details shown in step 203;

Step 104: excluding the (N₁+N₂) discrete parameter fields sampled in the previous step from the dataset D to form a label-free set U as a training set;

Step 105: setting a variable i that records the number of iterations, setting the value thereof to 0, and dividing the label-free set U into several batches of discrete parameter field samples;

Step 106: encoding the boundary conditions to form a mask tensor M of the boundary conditions with the same shapes and node solutions, and in M, setting an M element with the position corresponding to constrained degrees of freedom of nodes to 0 and other elements to 1;

Step 200: using a neural operator module F to predict node solutions of the discrete parameter field samples in the label-free set U, and further obtaining a discretized functional as a system functional estimate according to the node solutions, comprising the following substeps:

Step 201: taking a batch of discrete fiber angle field samples s from the label-free set U without replacement, if all the batches are sampled, the variable i increases by 1, judging whether a training process for neural operators meets the algorithm convergence condition, if yes, outputting the weight θ of the neural operators and executing step 304, if not, scrambling the label-free set U, redividing the scrambled label-free set U into several batches, and conducting resampling and training from the first batch, wherein the convergence condition can be that i reaches the maximum number of iterations for training or that the inference accuracy of the neural operators has met the accuracy requirement;

Step 202: inputting the samples s into the neural operator module F for inference, and using the mask tensor M to mask a tensor F(s) output by F to obtain a node solution a, as shown in formula (1.1):

$$a = F ( s ) M \qquad ( 1.1 )$$

In formula (1.1), ⊙ represents an element-wise product between tensors, the same below;

Step 203: conducting shift processing of the node solution a using the mean value (mean) and standard deviation (std) of all labels in the shift set L;

$$a = a std + mean \qquad ( 1.2 )$$

Step 204: performing convolution operation of the node solution a to obtain solutions and spatial derivatives thereof at the Gauss point;

Step 205: processing the solutions and the spatial derivatives thereof at the Gauss point using tensor operation to obtain the value of a functional integrand at the Gauss point;

Step 206: using a Gaussian quadrature rule to obtain a discretized functional estimate Π according to the value of the functional integrand at the Gauss point;

Step 300: performing variational operation of the discretized functional to construct optimization objectives, specifically: calculating the gradient R of the functional estimate Π with respect to the node solution a, taking the norm thereof as a minimized objective, acquiring an update stride Δa of the current node solution by iterative methods for systems of equations, and using Δa to update the weight θ of the neural operator module F, comprising the following substeps:

Step 301: carrying out backward propagation of the functional estimate Π by means of automatic differentiation, recording the gradient R of the functional estimate Π with respect to the node solution a, and taking the norm thereof as the minimized objective;

Step 302: inputting the gradient θ into the iterative methods for systems of equations to obtain the update stride Δa of the current node solution;

Step 303: using Δa to update the weight θ of the neural operators, and returning to step 201;

Step 304: performing inference of the neural operator module F on the test set T, and counting indexes in the test set.

Further, in step 101, the parameter space of PDEs can be a space formed by coefficients or free terms of the PDEs, the form of the parameter space of PDEs can be a continuous parameter field controlled by parameters, such as a B-spline surface and a Gaussian random field, or a function with such parameter field as an independent variable, and the sampling strategy can be sampling methods such as simple random sampling and Latin hypercube sampling.

Further, in step 102, the setting of meshing can be adjusted according to the specific research problems, and the sampling of the parameter space of PDEs can refer to the direct sampling of parameters of the PDEs or the sampling of independent variables that control the parameters of the PDEs, for example, heat source terms can be sampled directly for heat conduction PDEs that control heat conduction, while angles of axes of principle material coordinates that control stiffness coefficients in constitutive equations can be sampled for elastic mechanics PDEs that control fiber laminated elastic panels, i.e., fiber angle fields are sampled.

Further, in step 103, analytical methods used to solve the PDEs include a finite element method, a boundary element method, an isogeometric method, a meshfree method and other similar analytical methods.

Further, in step 105, the size and number of batches can be adjusted according to the specific research problems.

Further, in step 202, the neural operator module F includes but is not limited to a single neural operator and a combination of multiple neural operators, and the network structure of all neural networks of the neural operator module F and the hyperparameters of the network structure can be adjusted according to specific research problems.

Further, in step 205, the specific form of tensor operation of obtaining the functional integrand at the Gauss point from the solutions and the spatial derivatives thereof at the Gauss point can be adjusted according to the forms of the PDEs solved.

Further, in step 302, the iterative methods for systems of equations include but are not limited to a steepest descent method and a conjugate gradient method, the number of iteration steps of the iterative methods for systems of equations can be adjusted according to the specific research problems, and the maximum number of iterations for training can be adjusted according to the specific research problems.

Further, in step 303, various hyperparameters required for the updating process, such as learning rates and momenta, can be adjusted according to the specific research problems.

Further, in step 304, the indexes in the test set can be adjusted according to the specific research problems.

In a second aspect, a computer readable storage medium, comprising instructions which make the computer execute the method of any one of steps in the first aspect when running on the computer.

In a third aspect, a computer program product comprising instructions which make the computer execute the method of any one of steps in the first aspect when running on the computer.

The present invention has the following beneficial effects:

The present invention proposes a unified method, medium and product for training neural operators and solving partial differential equations (PDEs) based on variational principles, which incorporate solving and training processes into a unified framework. The solving and training processes of a purely data-driven method are carried out separately, and a large number of labels are required to construct optimization objectives. However, the present invention constructs label-free optimization objectives by estimating the output functional of the neural operators and introducing variational operations, so as to reduce the labels required in the training process, thus reducing the use of traditional solvers. A parameter set rather than a single parameter of PDEs needs to be solved in the fields of optimum design and uncertainty quantification. The traditional solvers such as solvers based on finite elements can only solve each parameter instance in the parameter set independently and then solve the whole parameter set iteratively. The present invention solves an operator from the parameter space to the solution space and learns the weight of a neural operator with generalization ability at the same time, which ensures that the accuracy of the present invention can be improved in other parameters while a certain parameter is solved concretely. The present invention is expected to replace traditional solvers in the fields where a large number of parameters of PDEs need to be solved such as optimum design and uncertainty quantification.

### DESCRIPTION OF DRAWINGS

FIG. 1 is a flow chart for implementation of a unified method, medium and product for training neural operators and solving PDEs based on variational principles provided by embodiments of the present invention;

FIG. 2 is a schematic diagram of boundary conditions in embodiment 1;

FIG. 3 is a schematic diagram of a network structure of a neural operator in embodiment 1;

FIG. 4 is an exposed view of five random samples from a test set in embodiment 1;

FIG. 5 is a schematic diagram of boundary conditions of a rectangular region P containing variable heat sources in embodiment 2;

FIG. 6 is an exposed view of five random samples from a test set in embodiment 2.

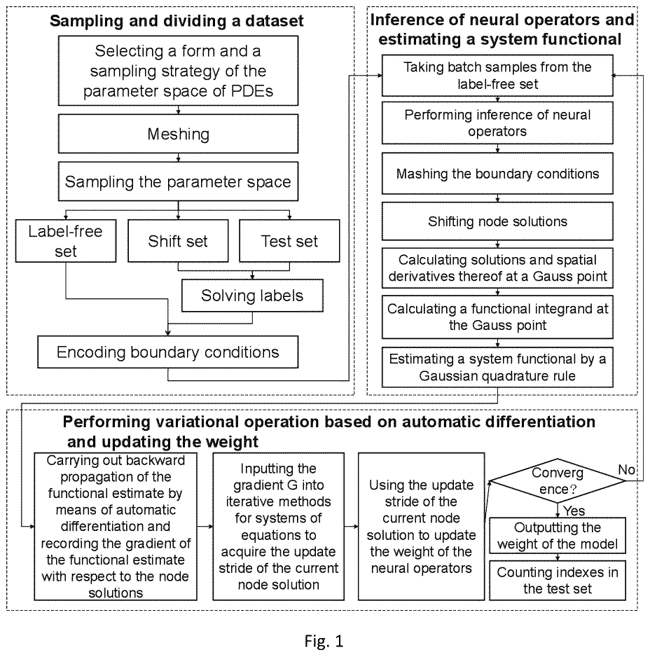

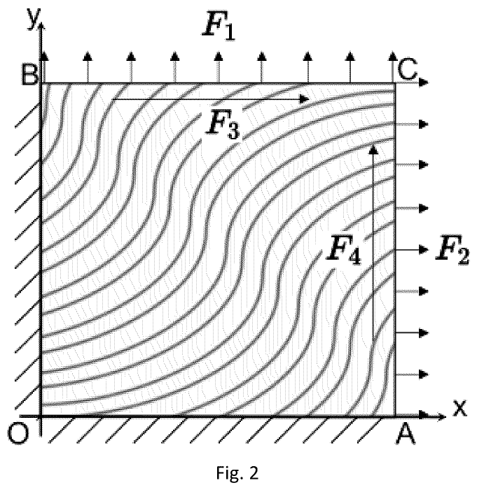

### DETAILED DESCRIPTION

To make the technical problem solved, the technical solution adopted and the technical effect achieved by the present invention more detailed, the present invention will be further described below in detail in combination with the drawings and the embodiments. It should be understood that the specific embodiments described herein are only used for explaining the present invention, not used for limiting the present invention. The described embodiments are merely part of the embodiments of the present invention, not all of the embodiments. Based on the embodiments in the present invention, other embodiments obtained by those ordinary skilled in the art without contributing creative labor will belong to the protection scope of the present invention. In addition, it should be noted that for ease of description, the drawings only show some portions related to the present invention rather than all portions.

### Embodiment 1

Embodiments of the present invention provide a unified method for training neural operators and solving PDEs based on variational principles, comprising the following steps:

Step 100: studying a variable stiffness fiber laminated elastic panel P, wherein the sizes, material properties and boundary conditions of the panel P are shown in step 103, sampling fiber angle fields of the panel P to form a label-free dataset D containing only discrete fiber angle fields, further dividing the dataset D into a shift set L, a test set T and a label-free set U, dividing the label-free set U into multiple batches, and encoding the boundary conditions to form a mask tensor of the boundary conditions, comprising the following substeps:

Step 101: selecting the form of the fiber angle fields as z-coordinate components of a 2-order B-spline surface controlled by a mesh of 4×4 control points, and fixing x and y components of the control points; and for a point (xₚ, yₚ), a fiber angle Z (xₚ, yₚ) is determined by formula (1.1):

$$Z ( {x}_{p} , {y}_{p} ) = {\sum }_{i = 0}^{3} {\sum }_{j = 0}^{3} {N}_{i , 2} ( {u}_{p} ) {N}_{j , 2} ( {v}_{p} ) {Z}_{i , j} \qquad ( 1.1 )$$

wherein (uₚ, vₚ) is a parameter coordinate of the point (xₚ, yₚ), N_{i,2} and N_{j,2} are basis functions of a (i+1)^{th} and a (j+1)^{th} control points in x and y directions respectively, i and j are control point labels in the x and y directions respectively, and Latin hypercube sampling is selected as the sampling strategy;

Step 102: for the fiber laminated elastic panel P under study, selecting bilinear reduced integral cells with four planar nodes, wherein the mesh setting adopts uniform meshing with a meshing density of 32×32 cells and a total of 33×33 nodes, and carrying out Latin hypercube sampling of the z-coordinates of 4×4 control points of the fiber angle fields, wherein the sampling range of all the z-coordinates is

$$( - \frac{π}{2} , \frac{π}{2} ) ,$$

so as to realize the sampling of the fiber angle fields, the number of the sampled fiber angle fields is 100000, and 14005 fiber angle fields are sampled randomly and discretized to form a label-free discrete fiber angle field dataset D containing only discrete fiber angle fields, wherein the fiber angle fields are dispersed at the Gauss point of the mesh, and the shape of the discrete fiber angle fields is 32×32×1;

Step 103: randomly sampling 2005 discrete fiber angle fields from the dataset D, obtaining node displacement solutions of PDEs corresponding to the 2005 discrete fiber angle fields, and taking the first five discrete fiber angle fields and the corresponding node displacement solutions as the shift set L and the remaining 2000 discrete fiber angle fields and the corresponding node displacement solutions as the test set T; the node displacement solutions in the present embodiment are obtained by ABAQUS commercial software, the S4R cell in the ABAQUS commercial software cell library is used in the calculation, the meshing in the ABAQUS software adopts uniform meshing, and the density of the mesh is 32×32 cells with a total of 33×33 nodes; the boundary conditions of the variable stiffness fiber laminated elastic panel P studied in the present embodiment are shown in FIG. 2; the sizes of the variable stiffness fiber laminated elastic panel P studied in the present embodiment are as follows: the panel P is square with the length and width of 100 mm, that is, OA-OB=100 mm, and the thickness of 0.125 mm; and the material properties of the panel P are as follows: the Young's modulus in the fiber direction is E₁=126000 MPa, the Young's modulus vertical to the fiber direction is E₂=11000 MPa, and the Poisson's ratio in a plane 1-2 is v₁₂=0.28; and the shear modulus in the plane 1-2 is G₁₂=6600 MPa, the boundary conditions of the panel P are as follows: the left side OA and the lower side OB of the panel P are fixed, an upward linear load F1 and a right linear load F3 are applied to the upper side BC, a right linear load F2 and an upper linear load F4 are applied to the right side AC, F1=5 N/mm, F3=5x N/mm, F2=5 N/mm, and F4-5y N/mm;

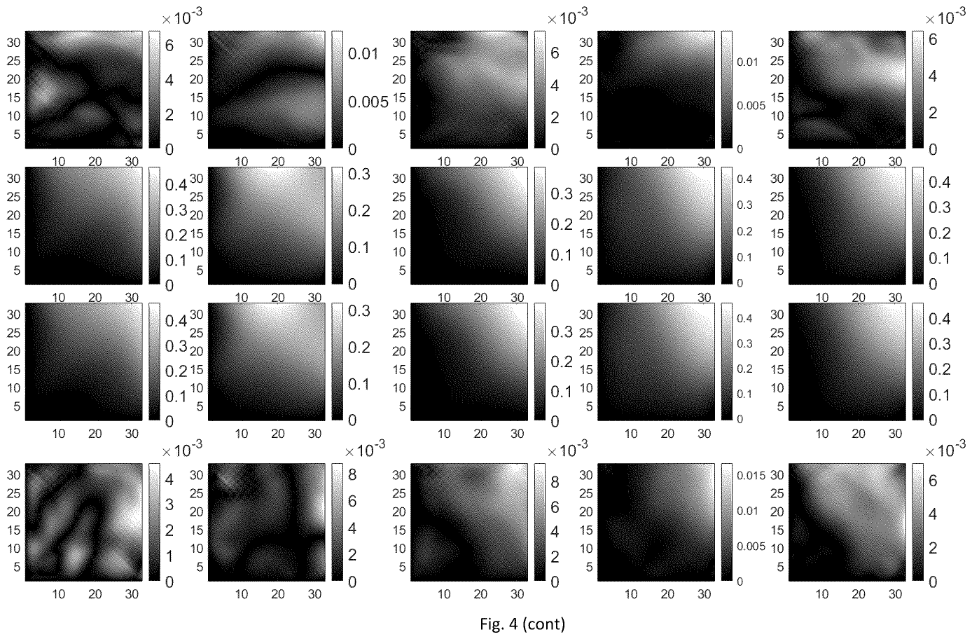

In the present embodiment, the exposed view of five random samples from the test set is shown in FIG. 4, wherein the five samples are presented in five columns, each column is one sample, the first row presents fiber paths of the five samples, the second row presents fiber angle fields of the five samples (unit: rad), the third row presents prediction of an x component of displacement node solutions of the five samples by the neural operators (unit: mm), the fourth row presents labels of the x component of displacement node solutions of the five samples (unit: mm), the fifth row presents absolute value errors of prediction of the x component of displacement node solutions of the five samples by the neural operators (unit: mm), the sixth row presents prediction of a y component of displacement node solutions of the five samples by the neural operators (unit: mm), the seventh row presents labels of the y component of displacement node solutions of the five samples (unit: mm), and the eighth row presents absolute value errors of prediction of the y component of displacement node solutions of the five samples by the neural operators (unit: mm).

Step 104: excluding the 2005 discrete fiber angle fields sampled in the previous step from the dataset D to obtain a label-free set U containing 12000 discrete fiber angle fields as a training set;

Step 105: setting a variable i that records the number of iterations, setting the value thereof to 0, and dividing the label-free set U into 12000 batches of discrete fiber angle field samples, wherein the size of each batch is 1;

Step 106: encoding the boundary conditions to form a mask tensor M of the boundary conditions with the shape of (1, 33, 33, 2), and in M, setting an M element with the position corresponding to constrained degrees of freedom of nodes to 0 and other elements to 1;

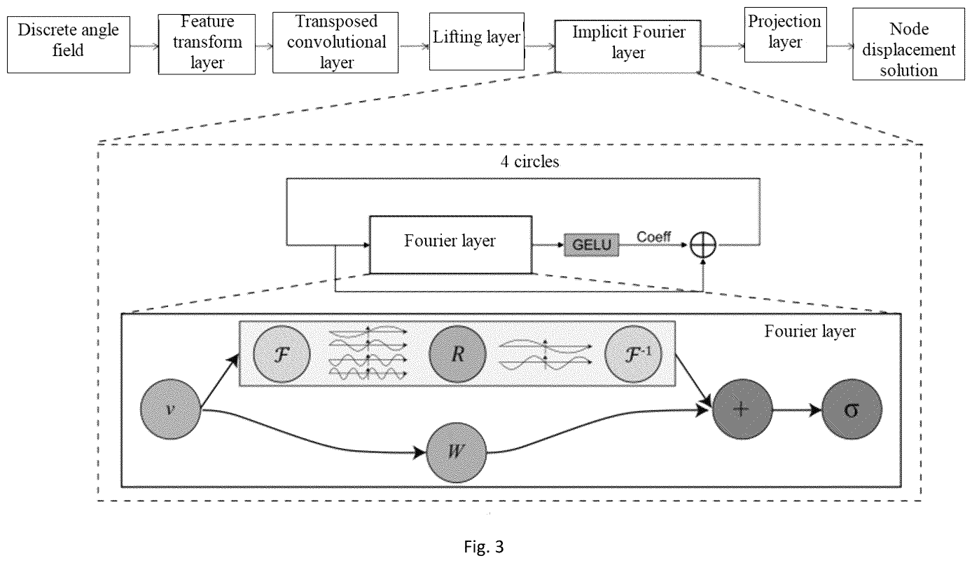

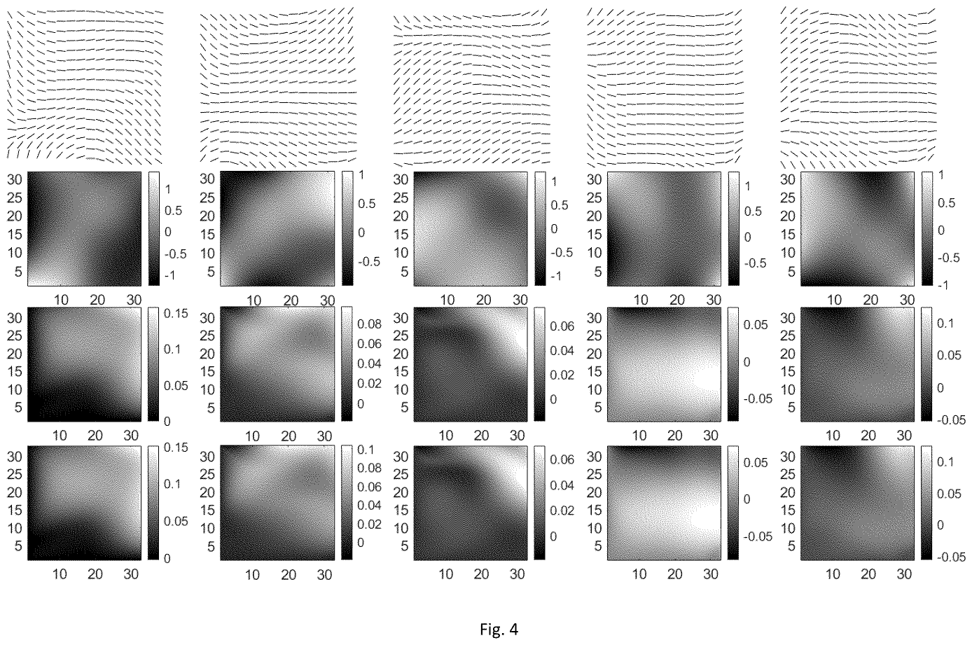

Step 200: using a neural operator module F, wherein F contains two implicit Fourier neural operators (IFNOs) with the same settings, each IFNO is responsible for the prediction of a displacement component, and the setting of each Fourier neural operator is shown in FIG. 3, predicting the node displacement with the shape of 32×32×2 corresponding to the discrete fiber angle field samples in the label-free set U, and further obtaining a discretized functional as a system functional estimate according to the node displacement, comprising the following substeps:

Step 201: taking a batch of discrete fiber angle field samples s from the label-free set U without replacement, if all the batches are sampled, the variable i increases by 1, judging whether a training process for neural operators meets the algorithm convergence condition, if yes, outputting the weight θ of the neural operators and executing step 304, if not, scrambling the label-free set U, redividing the scrambled label-free set U into 12000 batches, and conducting resampling and training from the first batch, wherein the convergence condition is that i reaches the maximum number of iterations for training, and the maximum number of iterations for training is 500 in the present embodiment;

Step 202: inputting the discrete fiber angle field samples s into the neural operator module F for inference, and using the mask tensor M to mask a tensor F(s) output by F to obtain a node displacement solution a, as shown in formula (1.2):

$$a = F ( s ) ⊙ M \qquad ( 1.2 )$$

Step 203: conducting shift processing of the node displacement a using the mean value tensor (mean) and standard deviation tensor (std) of all labels in the shift set L;

$$a = a ⊙ std + mean \qquad ( 1.3 )$$

Step 204: performing convolution operation of the node displacement a to obtain solutions and spatial derivatives thereof at the Gauss point;

Step 205: processing the solutions and the spatial derivatives at the Gauss point using tensor operation to obtain the value of a functional integrand at the Gauss point;

Step 206: using a Gaussian quadrature rule to obtain a discretized functional Π according to the value of the functional integrand at the Gauss point, as shown in formula (1.4);

$$\tilde{Π} = {\sum }_{e} {Π}^{e} \approx \frac{1}{2} {\sum }_{e} {\sum }_{l = 1}^{{n}_{g}} {H}_{l} {a}^{e T} {B}_{l}^{T} {D}_{l} {B}_{l} {a}^{e} \vert {J}_{l}^{e} \vert - {\sum }_{e} {\sum }_{l = 1}^{{n}_{g}} {H}_{l} {a}^{e T} {N}_{l}^{T} {f}_{l} \vert {J}_{l}^{e} \vert - {\sum }_{e} {\sum }_{m = 1}^{{n}_{{s}_{σ}^{e}}} {\sum }_{l = 1}^{{n}_{m}} {I}_{m l} {a}^{e T} {N}_{m l}^{T} {\overline{X}}_{m l} \vert {J}_{m l}^{{S}_{σ}^{e}} \vert \qquad ( 1.4 )$$

wherein a^{e} represents the node displacement of each cell, the subscript “l” is a value at an l^{th} integral point in the cell, N represents a shape function matrix, B represents a strain-displacement matrix, D represents a matrix of material properties, Je represents a Jacobian matrix of the cell, f represents a body force, X̅ represents a surface force, and H₁ and Iₘₗ represent the weight of the l^{th} integral point in the cell and the weight of an l^{th} integral point of boundaries of an m^{th} cell respectively.

Step 300: performing variational operation of the discretized functional \tilde{Π}, specifically: calculating the gradient R of the functional estimate Π with respect to the node displacement a, taking the norm thereof as a minimized objective, acquiring an update stride Δa of the current node displacement by iterative methods for systems of equations, and using Δa to update the weight θ of the neural operator module F, comprising the following substeps:

Step 301: carrying out backward propagation of the functional estimate \tilde{Π} by means of automatic differentiation, recording the gradient R of the functional estimate \tilde{Π} with respect to the node displacement a, as shown in formula (1.5), and taking the norm of R as the minimized objective;

$$R = \frac{\partial \tilde{Π}}{\partial a} \qquad ( 1.5 )$$

Step 302: inputting the gradient R into a conjugate gradient method in which two iteration steps are executed to obtain the update stride Δa of the current node displacement;

Step 303: based on a random gradient descent method, using Δa to update the weight θ of the neural operators, setting the learning rate to 1, and then returning to step 201;

Step 304: performing inference of the neural operator module F on the test set T, and selecting an index in the test set as the average relative 2-norm error, as shown in formula (1.6);

$$Metric = \frac{1}{2000} {\sum }_{i = 1}^{2000} \frac{{‖ a - \hat{a} ‖}_{2}}{{‖ \hat{a} ‖}_{2}} \qquad ( 1.6 )$$

The functional description and hyperparameter settings of each layer of the neural operator network in the present embodiment are shown in Table 1:

TABLE 1

| | Feature | | Transposed | | | | | | | |
|---|---|---|---|---|---|---|---|---|---|---|
| | Transform | | Convolutional | | | | | | | |
| | Layer | | Layer | | Lifting Layer | | Fourier Layer | | Projection Layer | |
| Functional | Carrying out | | Adjusting the | | Adjusting the | | Carrying out | | Adjusting the | |
| description | feature | | sizes of the | | number of | | feature | | channels through | |
| | transformation | | feature map | | channels | | transformation and | | a linear layer A, a | |
| | of discrete angle | | | | through linear | | learning in the | | GELU activation | |
| | fields to convert | | | | transformation | | frequency domain | | function and a | |
| | a single-channel | | | | | | | | linear layer B | |
| | discrete angle | | | | | | | | | |
| | field θ into the | | | | | | | | | |
| | following four | | | | | | | | | |
| | channels: sin θ, | | | | | | | | | |
| | cos θ, sin 2θ | | | | | | | | | |
| | and cos 2θ | | | | | | | | | |
| Network | Number | 1 | Kernel | 2 × 2 | Number | 4 | Number of | 16 | Linear layer A | |
| hyperparameter | of input | | size | | of input | | input modes | | | |
| setting | channels | | Padding | 0 | channels | | | | | |
| | | | Stride | 1 | | | Number of | 16 | Number | 32 |
| | | | | | | | transformation | | of input | |
| | | | | | | | modes | | channels | |
| | Number | 4 | Number | 4 | Number | 32 | | | Number | 128 |
| | of | | of input | | of | | | | of | |
| | output | | channels | | output | | | | output | |
| | channels | | | | channels | | | | channels | |

| Number | 4 | Number of | 32 | Linear layer B | |
|---|---|---|---|---|---|
| of | | input channels | | | |
| output | | Number of | 32 | Number | 128 |
| channels | | output | | of input | |
| | | channels | | channels | |
| | | | | Number | 1 |
| | | | | of | |
| | | | | output | |
| | | | | channels | |

In a second aspect, a computer readable storage medium, comprising instructions which make the computer execute the method of any one of steps in the first aspect when running on the computer.

In a third aspect, a computer program product comprising instructions which make the computer execute the method of any one of steps in the first aspect when running on the computer.

In view of the defects of existing data-driven neural operator training methods and traditional solvers, the present invention proposes a unified method, medium and product for training neural operators and solving PDEs based on variational principles. Composites are widely used in aerospace, sports equipment, automobile manufacturing and other industries, and variable stiffness composites are favored in lightweight design because of the ability to maximize mechanical bearing performance through optimum design of fiber paths. Variable angle fiber laminates form a basic component of variable stiffness composites, and it is of great significance to achieve real-time batch analysis of mechanical response of variable angle fiber laminates for accelerating the optimal design of variable stiffness composites. Embodiment 1 of the present invention achieves an average relative 2-norm error of 2.93% on a test set with a capacity of 2000 for simulation of anisotropic variable angle fiber laminates under the conditions that the shift set L uses only five labels and the training set is completely label-free, which has reached a purely data-driven training error level, so as to prove that the present invention can be applied to the real-time low-cost and high-efficiency batch simulation analysis of the mechanical response of the variable angle fiber laminates. Since no data-driven training error term is used, the present invention can save the time and computing power of generating a large number of labels required for constructing data-driven error terms, and two tasks of solving PDEs and training neural operators are unified in a single framework, providing strong support for downstream applications such as optimum design and inverse problems.

### Embodiment 2

In a first aspect, the present invention provides a unified method for training neural operators and solving PDEs based on variational principles, comprising the following steps:

Step 100: studying the problem of heat transfer in a rectangular region P containing variable heat sources, wherein the sizes and boundary conditions of the region are shown in step 103, sampling the heat sources to form a label-free dataset D containing only discrete heat source fields, further dividing the dataset D into a shift set L, a test set T and a label-free set U, dividing the label-free set U into multiple batches, and encoding the boundary conditions to form a mask tensor of the boundary conditions, comprising the following substeps:

Step 101: selecting the form of the heat source fields as a Gaussian random field:

$$Q ( x ) ∼ GP ( 0 , {k}_{l} ( x , {x}^{′} ) ) W / {m}^{2} \qquad ( 1.1 )$$

$${k}_{l} ( x , {x}^{′} ) = σ {e}^{\frac{{‖ x - {x}^{′} ‖}^{2}}{2 {l}^{2}}} W / {m}^{2}$$

wherein

$$l = \frac{1}{2} , σ = 1 ,$$

and simple random sampling is selected as the sampling strategy; wherein

Step 102: for the rectangular region P containing variable heat sources under study, selecting bilinear cells with four planar nodes, wherein the mesh setting adopts uniform meshing with a meshing density of 30×30 cells and a total of 31×31 nodes, and carrying out simple random sampling and discretization of the heat source fields with the sampling number of 12010, so as to form a label-free dataset D containing only discrete heat source fields, wherein the heat source fields are dispersed at the Gauss point of the mesh, and the shape of the discrete heat source fields is 30×30×1;

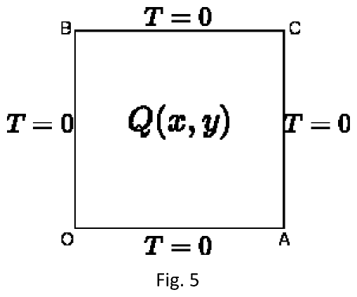

Step 103: randomly sampling 2010 discrete heat source fields from the dataset D, obtaining node temperature solutions of PDEs corresponding to the 2010 discrete heat source fields, and taking the first ten discrete heat source fields and the corresponding node temperature solution labels as the shift set L and the remaining 2000 discrete heat source fields and the corresponding node temperature solution labels as the test set T; the node temperature solution labels in the present embodiment are obtained by COMSOL commercial software, the bilinear cells with four planar nodes in the COMSOL commercial software cell library are used in the calculation, and the meshing in the COMSOL software adopts uniform meshing with a meshing density of 30×30 cells and a total of 31×31 nodes; the boundary conditions of the rectangular region P containing variable heat sources studied in the present embodiment are shown in FIG. 5; and in the present embodiment, the length and width of the region P are both 1 m, that is, OA=OB=1 m, and the four boundaries of the region P are set to Dirichlet boundary conditions with a temperature of 0° C.;

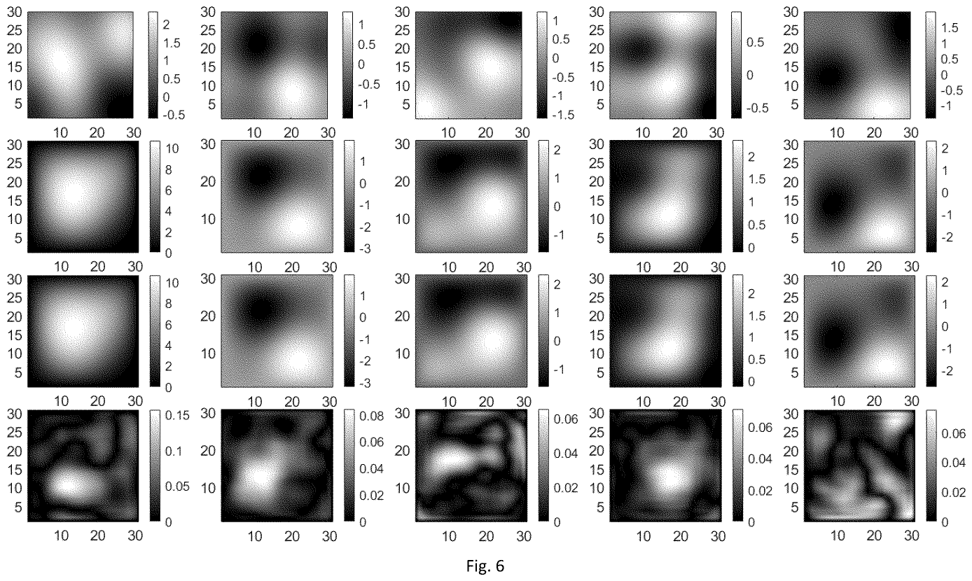

In the present embodiment, the exposed view of five random samples from the test set is shown in FIG. 6, wherein the five samples are presented in five columns, each column is one sample, the first row presents heat source fields of the five samples (unit: W/m²), the second row presents temperature node solutions of the neural operators for the five samples (unit: ° C.), the third row presents temperature node solution labels of the five samples (unit: ° C.), and the fourth row presents absolute value errors of temperature node solutions of the five samples predicted by the neural operators (unit: ° C.).

Step 104: excluding the 2010 discrete heat source fields sampled in the previous step from the dataset D to obtain a label-free set U containing 10000 discrete heat source fields as a training set;

Step 105: setting a variable i that records the number of iterations, setting the value thereof to 0, and dividing the label-free set U into 157 batches of discrete heat source field samples, wherein the size of each of 156 batches is 64, and the size of the last batch is 16;

Step 106: encoding the boundary conditions to form a mask tensor M of the boundary conditions with the shape of (1, 31, 31, 1), and in M, setting an M element with the position corresponding to constrained degrees of freedom of nodes to 0 and other elements to 1;

Step 200: using a neural operator module F, wherein F contains one implicit Fourier neural operator (IFNO), which is responsible for the prediction of temperature, predicting the node temperature with the shape of 31×31×1 corresponding to the discrete heat source field samples in the label-free set U, and further obtaining a discretized functional as a system functional estimate according to the node temperature, comprising the following substeps:

Step 201: taking a batch of discrete fiber angle field samples s from the label-free set U without replacement, if all the batches are sampled, the variable i increases by 1, judging whether a training process for neural operators meets the algorithm convergence condition, if yes, outputting the weight θ of the neural operators and executing step 304, if not, scrambling the label-free set U, redividing the scrambled label-free set U into 157 batches, wherein the size of each of 156 batches is 64, and the size of the last batch is 16, and conducting resampling and training from the first batch, wherein the convergence condition is that i reaches the maximum number of iterations for training, and the maximum number of iterations for training is 5000 in the present embodiment;

Step 202: inputting the discrete heat source field samples s into the neural operator module F for inference, and using the mask tensor M to mask a tensor F(s) output by F to obtain a node temperature solution a, as shown in formula (1.2):

$$a = F ( s ) ⊙ M \qquad ( 1.2 )$$

Step 203: conducting shift processing of the node temperature a using the mean value tensor (mean) and standard deviation tensor (std) of all labels in the shift set L;

$$a = a ⊙ std + mean \qquad ( 1.3 )$$

Step 204: performing convolution operation of the node temperature a to obtain solutions and spatial derivatives thereof at the Gauss point;

Step 205: processing the solutions and the spatial derivatives at the Gauss point using tensor operation to obtain the value of a functional integrand at the Gauss point;

Step 206: using a Gaussian quadrature rule to obtain a discretized temperature functional \tilde{Π} according to the value of the functional integrand at the Gauss point;

Step 300: performing variational operation of the discretized temperature functional \tilde{Π} specifically: calculating the gradient R of the functional estimate \tilde{Π} with respect to the node temperature a, taking the norm thereof as a minimized objective, acquiring an update stride Δa of the current node temperature by iterative methods for systems of equations, and using Δa to update the weight θ of the neural operator module F, comprising the following substeps:

Step 301: carrying out backward propagation of the functional estimate \tilde{Π} by means of automatic differentiation, recording the gradient R of the functional estimate \tilde{Π} with respect to the node temperature a, as shown in formula (1.4), and taking the norm of R as the minimized objective;

$$R = \frac{\partial \tilde{Π}}{\partial a} \qquad ( 1.4 )$$

Step 302: inputting the gradient R into a conjugate gradient method in which two iteration steps are executed to obtain the update stride Δa of the current node temperature;

Step 303: based on a random gradient descent method, using Δa to update the weight θ of the neural operators, setting the learning rate to 1e-5, and then returning to step 201;

Step 304: performing inference of the neural operator module F on the test set T, and selecting an index in the test set as the average relative 2-norm error, as shown in formula (1.5);

$$Metric = \frac{1}{2000} {\sum }_{i = 1}^{2000} \frac{{‖ a - \hat{a} ‖}_{2}}{{‖ \hat{a} ‖}_{2}} \qquad ( 1.5 )$$

In a second aspect, a computer readable storage medium, comprising instructions which make the computer execute the method of any one of steps in the first aspect when running on the computer.

In a third aspect, a computer program product comprising instructions which make the computer execute the method of any one of steps in the first aspect when running on the computer.

In view of the defects of existing data-driven neural operator training methods and traditional solvers, the present invention proposes a unified method, medium and product for training neural operators and solving PDEs based on variational principles. The problem of heat transfer widely exists in various engineering technology fields such as energy and power, metallurgy, chemical industry, transportation, building materials and machinery, traditional industries such as food, light industry, textile and medicines, and high-tech fields such as aerospace, nuclear energy, microelectronics, materials, biomedical engineering, environmental engineering, new energy and agricultural engineering. The accurate real-time batch simulation of heat transfer phenomena can help to better understand and grasp the heat transfer phenomena, so as to better apply in practical production and life, for example, to simulate and optimize heat transfer phenomena in industrial production processes, increase production efficiency, and improve product quality; to simulate and optimize heat transfer phenomena of buildings and improve energy-saving performance of buildings; and to simulate and optimize heat transfer phenomena of electronic equipment and improve heat dissipation performance of electronic equipment. Embodiment 2 of the present invention achieves an average relative 2-norm error of only 2.20% on a test set with a capacity of 2000 in the study of the problem of heat transfer in the rectangular region P containing variable heat sources under the conditions that the shift set L uses only ten labels and the training set is completely label-free, which has reached a purely data-driven training error level, so as to prove that the present invention can be applied to the accurate real-time batch simulation of heat transfer phenomena. Since no data-driven training error term is used, the present invention can save the time and computing power of generating a large number of labels required for constructing data-driven error terms, and two tasks of solving PDEs and training neural operators are unified in a single framework, providing strong support for downstream applications such as optimum design and inverse problems.

Finally, it should be noted that the above embodiments are only used for describing the technical solution of the present invention rather than limiting the present invention. Although the present invention is described in detail by referring to the above embodiments, those ordinary skilled in the art should understand that: the amendments to the technical solution recorded in each of the above embodiments or the equivalent replacements for part of or all the technical features therein do not enable the essence of the corresponding technical solution to depart from the scope of the technical solution of various embodiments of the present invention.

1. A unified method for training neural operators and solving PDEs based on variational principles, comprising the following steps:
step 100: sampling the parameter space of PDEs to form a label-free dataset D containing only discrete parameter fields, dividing the dataset D into a shift set L, a test set T and a label-free set U, dividing the label-free set U into multiple batches, and encoding boundary conditions to form a mask tensor of the boundary conditions;
step 200: using a neural operator module F to predict node solutions of the discrete parameter field samples in the label-free set U, and obtaining a discretized functional as a system functional estimate according to the node solutions;
step 300: performing variational operation of the discretized functional to construct optimization objectives, calculating the gradient R of the functional estimate Π with respect to the node solution a, taking the norm thereof as a minimized objective, acquiring an update stride Δa of the current node solution by iterative methods for systems of equations, and using Δa to update the weight θ of the neural operator module F.

2. The unified method for training neural operators and solving PDEs based on variational principles according to claim 1, wherein step 100 comprises the following substeps:
step 101: selecting a form and a sampling strategy of the parameter space of PDEs;
step 102: meshing the solution domain of PDEs, sampling the parameter space of PDEs according to the sampling strategy selected in step 101, and discretizing sampled parameter fields at a Gauss point of the mesh to form a label-free discrete parameter field dataset D containing only discrete parameter fields;
step 103: randomly sampling (N₁+N₂) discrete parameter fields from the discrete parameter field dataset D, obtaining node solutions of PDEs corresponding to the (N₁+N₂) discrete parameter fields, and taking the first N₁ discrete parameter fields and the corresponding node solutions as the shift set L and the remaining N₂ discrete parameter fields and the corresponding node solutions as the test set T, wherein the shift set L is used for shifting the output range;
step 104: excluding the (N₁+N₂) discrete parameter fields sampled in the previous step from the dataset D to form a label-free set U as a training set;
step 105: setting a variable i that records the number of iterations, setting the value thereof to 0, and dividing the label-free set U into several batches of discrete parameter field samples;
step 106: encoding the boundary conditions to form a mask tensor M of the boundary conditions with the same shapes and node solutions, and in M, setting an M element with the position corresponding to constrained degrees of freedom of nodes to 0 and other elements to 1.

3. The unified method for training neural operators and solving PDEs based on variational principles according to claim 2, wherein step 200 comprises the following substeps:
step 201: taking a batch of discrete fiber angle field samples s from the label-free set U without replacement, if all the batches are sampled, the variable i increases by 1, judging whether a training process for neural operators meets the algorithm convergence condition, if yes, outputting the weight θ of the neural operators and executing step 304, if not, scrambling the label-free set U, redividing the scrambled label-free set U into several batches, and conducting resampling and training from the first batch, wherein the convergence condition can be that i reaches the maximum number of iterations for training or that the inference accuracy of the neural operators has met the accuracy requirement;
step 202: inputting the samples s into the neural operator module F for inference, and using the mask tensor y to mask a tensor F(s) output by F to obtain a node solution a, as shown in formula (1.1):
$$a = F ( s ) ⊙ M \qquad ( 1.1 )$$
in formula (1.1), ⊙ represents an element-wise product between tensors, the same below;
step 203: conducting shift processing of the node solution a using the mean value (mean) and standard deviation (std) of all labels in the shift set L;
$$a = a ⊙ std + mean \qquad ( 1.2 )$$
step 204: performing convolution operation of the node solution a to obtain solutions and spatial derivatives thereof at the Gauss point;
step 205: processing the solutions and the spatial derivatives thereof at the Gauss point using tensor operation to obtain the value of a functional integrand at the Gauss point;
step 206: using a Gaussian quadrature rule to obtain a discretized functional estimate/I according to the value of the functional integrand at the Gauss point.

4. The unified method for training neural operators and solving PDEs based on variational principles according to claim 3, wherein step 300 comprises the following substeps:
step 301: carrying out backward propagation of the functional estimate Π by means of automatic differentiation, recording the gradient R of the functional estimate Π with respect to the node solution a, and taking the norm thereof as the minimized objective;
step 302: inputting the gradient R into the iterative methods for systems of equations to obtain the update stride Δa of the current node solution;
step 303: using 4a to update the weight θ of the neural operators, and returning to step 201;
step 304: performing inference of the neural operator module F on the test set T, and counting indexes in the test set.

5. The unified method for training neural operators and solving PDEs based on variational principles according to claim 3, wherein in step 202, the neural operator module F is a single neural operator or a combination of multiple neural operators.

6. A computer readable storage medium, comprising instructions which make the computer execute the unified method of claim 1 when running on the computer.

7. A computer program product comprising instructions, wherein the computer program product makes the computer execute the unified method of claim 1 when running on the computer.
